(19) United States
(12) Patent Application Publication
(10) Pub. No.: US 2014/0286056 A1
(43) Pub. Date: Sep. 25, 2014

(54) SWITCH CONTROL CIRCUIT, POWER SUPPLY DEVICE COMPRISING THE SAME AND DRIVING METHOD OF THE POWER SUPPLY DEVICE

(71) Applicant: FAIRCHILD KOREA SEMICONDUCTOR LTD., Bucheon-si (KR)

(72) Inventors: Jaehan YOON, Bucheon-si (KR); Byunghak AHN, Seoul (KR)

(73) Assignee: FAIRCHILD KOREA SEMICONDUCTOR LTD., Bucheon-si (KR)

(21) Appl. No.: 14/222,487

(22) Filed: Mar. 21, 2014

(30) Foreign Application Priority Data
Mar. 22, 2013 (KR) 10-2013-0031119

(51) Int. Cl. H02M 3/335

(52) U.S. Cl. CPC H02M 3/33569
USPC 363/21.03

(57) ABSTRACT

The invention relates to a switch control circuit, a power supply including the same, and a method for driving the power supply. The power supply includes: a first switch; a second switch coupled in series to the first switch; a transistor coupled to a node where the first switch and the second switch are coupled; a resonance capacitor coupled between the transformer and a primary side ground and to which a resonance current flows; a sense circuit generating a first sense voltage that depends on the resonance current when the resonance current is a positive current; and a switch control circuit detecting a zero voltage switching failure by sensing the resonance current using the first sense voltage at a turn-off time of the first switch for every switching cycle of the first and second switches.

### CROSS-REFERENCE TO RELATED APPLICATION

This application claims priority to and the benefit of Korean Patent Application No. 10-2013-0031119 filed in the Korean Intellectual Property Office on Mar. 22, 2013, the entire contents of which are incorporated herein by reference.

### BACKGROUND

(a) Field

The invention relates to a switch control circuit, a power supply including the same, and a driving method of the power supply.

(b) Description of the Related Art

Zero voltage switching is required to reduce a switching loss of a resonance converter. When the zero voltage switching is failed, a power loss is increased.

Thus, a means for sensing a zero voltage switching failure and a means for controlling a switching operation with zero voltage switching when the zero voltage switching failure is sensed are needed.

The above information disclosed in this Background section is only for enhancement of understanding of the background of the invention and therefore it may contain information that does not form the prior art that is already known in this country to a person of ordinary skill in the art.

### SUMMARY

The invention has been made in an effort to provide a switch control circuit that can sense a zero voltage switching failure and control a switching operation with zero voltage switching when the zero voltage switching failure is sensed, a power supply including the same, and a method for driving the power supply.

A power supply according to one aspect of the invention includes: a first switch; a second switch coupled in series to the first switch; a transistor coupled to a node where the first switch and the second switch are coupled; a resonance capacitor coupled between the transformer and a primary side ground and to which a resonance current flows; a sense circuit to generate a first sense voltage that depends on the resonance current when the resonance current is a positive current; and a switch control circuit to detect a zero voltage switching failure by sensing the resonance current using the first sense voltage at a turn-off time of the first switch for every switching cycle of the first and second switches.

The transformer includes a magnetizing inductor and a leakage inductor coupled in series to the resonance capacitor.

The sense circuit includes: a sense capacitor coupled in parallel with the resonance capacitor; a first diode including an anode coupled to the sense capacitor; a first resistor coupled between a cathode of the diode and a ground; and a first capacitor coupled in parallel with the first resistor, and the first sense voltage is a voltage of the first resistor.

The sense circuit further includes a second resistor coupled between the sense capacitor and the first diode.

The sense circuit generates a second sense voltage when the resonance current is a negative current, and the second sense voltage is used in sensing of over-current.

The sense circuit further includes: a second diode including a cathode coupled to the sense capacitor through a second resistor; a third resistor coupled between an anode of the second diode and a ground; and a second capacitor coupled in parallel with the third resistor. The second sense voltage is a voltage of the second resistor.

The power supply further includes a reference voltage setting unit that sets a zero voltage switching reference voltage for detection of the zero voltage switching failure.

The reference voltage sensing unit includes a third resistor to which a current supplied from the switching control circuit flows and a third capacitor coupled in parallel with the third resistor.

The switch control circuit turns on a first high-side switch in the next switching cycle rather than turning on the second switch in a switching cycle in which the zero voltage switching failure is detected.

The switching control circuit includes a zero voltage switching detector to detect whether the zero voltage switching is failed according to a result of comparison between the first sense voltage and a predetermined zero voltage switching reference voltage at a turn-off time of the first switch.

The zero voltage switching detector includes: a comparator to compare the first sense voltage and the zero voltage switching reference voltage and to output a comparison signal according to a comparison result; a half subtractor to generate a subtraction signal according to a voltage difference between the comparison signal and a first gate voltage supplied to a gate of the first switch; an SR latch to reset an output generated by the first gate voltage according to the subtraction signal; and a logic gate to generate a zero voltage switching detection signal by performing a logic operation on the first gate voltage and an output signal of the SR latch.

The comparator includes a non-inverse terminal to which the first sense voltage is input and an inverse terminal to which the zero voltage switching reference voltage is input, and outputs a high-level comparison signal when an input of the non-inverse terminal is higher than an input of the inverse terminal and outputs a low-level comparison signal in the opposite case.

The half subtractor generates a high-level subtraction signal when a voltage obtained by subtracting the first gate voltage from the comparison signal is higher than zero voltage, and generates a low-level subtraction signal in the opposite case.

The half subtractor includes an NOR gate to invert the first gate voltage and an AND gate to perform an AND operation on the inverted first gate voltage and the comparison signal.

The logic gate generates a high-level zero voltage switching detection signal when one of the two inputs is high level and generates a low-level zero voltage switching detection signal when both of the two inputs are high level or low level.

The power supply further includes a gate driving circuit to generate a first gate voltage and a second gate voltage according to an oscillator signal that determines switching frequencies of the first and second switches and to disable a second gate voltage of the corresponding switching cycle during which detection of a zero voltage switching failure is input from the zero voltage switching detector.

According to another aspect of the invention, a driving method is applied to a power supply including a first switch, a second switch, and a resonance capacitor coupled between a transformer coupled to a node where the first switch and the second switch are coupled and a primary side ground, the first switch and the second switch being coupled in series.

The driving method of the power supply includes: generating a first sense voltage that depends on a resonance current when a current flowing to the resonance capacitor is a positive current; detecting a zero voltage switching failure according to a result of comparison between the first sense voltage and a predetermined zero voltage switching detection voltage at a turn-off time of the first switch for every switching cycle of the first and second switches; and maintaining the second switching in a turn-off state during the corresponding switching cycle in which the zero voltage switching failure is detected.

The detecting the zero voltage switching failure includes detecting the zero voltage switching to be failed when the first sense voltage is lower than the zero voltage switching detection voltage at a turn-off time of the first switch.

A switch control circuit according to another aspect of the invention is applied to a power supply including a first switch, a second switch, and a resonance capacitor coupled between a transformer coupled to a node where the first switch and the second switch are coupled and a primary side ground, the first switch and the second switch being coupled in series.

The switch control circuit includes: a comparator to compare a first sense voltage generated when a resonance current flowing to the resonance capacitor with a predetermined zero voltage switching reference voltage and to output a comparison signal according to a result of the comparison; a half subtractor to generate a subtraction signal according to a voltage difference between the comparison signal and a first gate voltage supplied to a gate of the first switch; an SR latch to reset an output generated by the first gate voltage according to the subtraction signal; and a logic gate to generate a zero voltage switching detection signal by performing a logic operation on the first gate voltage and an output signal of the SR latch.

Then the zero voltage switching detection signal indicates a failure of zero voltage switching, the switch control circuit turns on a first high-side switch in the next switching cycle rather than turning on the second switch in the corresponding switching cycle.

The switch control circuit generates a gate voltage of the second switch is generated using an oscillator signal that determines switching frequencies of the first and second switches, a signal generated by being delayed by a predetermined dead time from the oscillator, and a gate voltage of the second switch using an output of the logic gate.

The half subtractor includes an NOR gate to invert the first gate voltage and an AND gate to perform an AND operation on the inverted first gate voltage and the comparison signal.

According to the exemplary embodiments of the invention, a switch control circuit that can sense a zero voltage switching failure and control a switching operation with zero voltage switching when the zero voltage switching failure is sensed, a power supply including the same, and a method for driving the power supply can be provided.

### BRIEF DESCRIPTION OF THE DRAWINGS

FIG. 1 shows a power supply according to an exemplary embodiment of the invention.

FIG. 2 shows a switch control circuit according to the exemplary embodiment of the invention.

FIG. 3 shows a connection relationship between the switch control circuit and a reference voltage generator according to the exemplary embodiment of the invention.

FIG. 4 shows a half subtractor according to the exemplary embodiment of the invention.

FIG. 5 is a waveform diagram of an high-side gate voltage, a low-side gate voltage, a resonance current, drain current, a first sense voltage, a comparison signal, a subtraction signal, an output signal of an SR latch, and a zero voltage switching detection signal according to the exemplary embodiment of the invention.

FIG. 6 is a waveform diagram of a high-side gate voltage, a low-side gate voltage, a resonance current, a drain current, a first sense voltage, a comparison signal, a subtraction signal, an output signal of an SR latch, and a zero voltage switching detection signal according to the exemplary embodiment of the invention, when the zero voltage switching is failed.

### DETAILED DESCRIPTION OF THE EMBODIMENTS

In the following detailed description, only certain exemplary embodiments of the invention have been shown and described, simply by way of illustration. As those skilled in the art would realize, the described embodiments may be modified in various different ways, all without departing from the spirit or scope of the invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

Hereinafter, a switch control circuit according to an exemplary embodiment of the invention, a power supply including the switch control circuit and a driving method thereof will be described with the accompanying drawings.

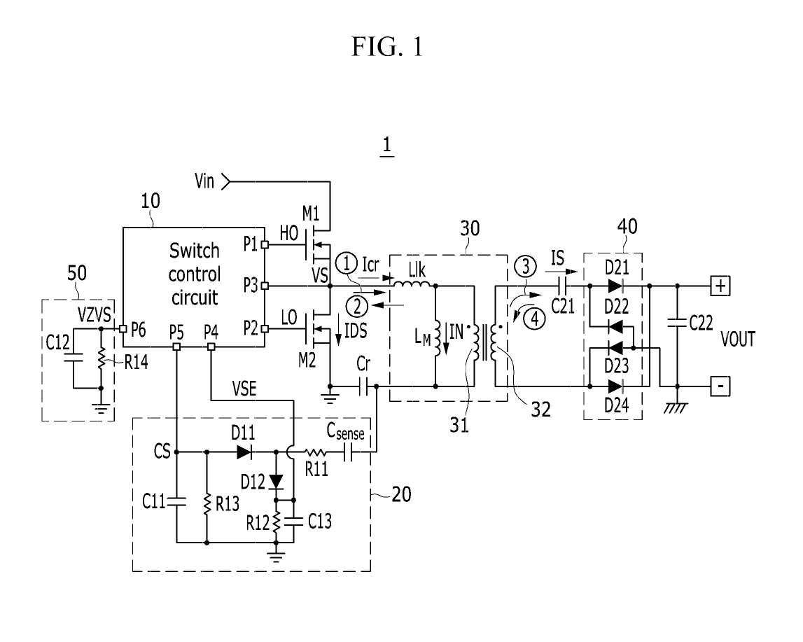

FIG. 1 shows a power supply according to an exemplary embodiment of the invention.

A power supply 1 converts an input voltage Vin to a square wave through a switching operation of an high-side switch M1 and a low-side switch M2, and generates power by passing the square wave through a resonance network. A primary side of the power supply 1 to which the input voltage Vin is input and a secondary side of the power supply 1 connected with output terminals (+ and −) are insulated from each other. A voltage between the output terminals (+ and −) is referred to as an output voltage VOUT.

In FIG. 1, the primary side and the secondary side are insulated from each other, but the exemplary embodiment of the invention is not limited thereto. The primary side and the secondary side of the power supply 1 that employs the switch control circuit and the switch control method according to the exemplary embodiment of the invention may not be insulated from each other. In addition, the output terminals of the power supply 1 may be realized as multiple output terminals by using multiple wires (e.g., although it is not illustrated, a plurality of wires are connected in parallel with each other in the secondary side). In this case, the power supply 1 may provide a plurality of output voltages, including the output voltage VOUT.

The high-side switch M1 and the low-side switch M2 are alternately turned on such that a driving voltages VS that swings between a primary side ground and the input voltage Vin are generated. In the exemplary embodiment of the invention, the high-side switch M1 and the low-side switch M2 are n-type transistors.

A drain of the high-side switch M1 is connected to the input voltage Vin, and an high-side gate signal HO is supplied to a gate of the high-side drain M1 through a pin P1. A drain of the low-side switch M2 is connected to a source of the high-side switch M1, and a low-side gate signal LO is supplied to a gate of the low-side switch M2 through a pin P2. A source of the low-side switch M2 is connected to the primary side ground. The driving voltage VS is a voltage at a node to which the source of the high-side switch M1 and the drain of the low-side switch M2 are connected.

While the high-side switch M1 is turned on by a high-level high-side gate signal HO, the low-side switch M2 is turned off by a low-level low-side gate signal LO

On the contrary, while the low-side switch M2 is turned on by a high-level low-side gate signal LO, the high-side switch M1 is turned off by a low-level high-side gate signal HO.

The resonance network of the power supply 1 according to the exemplary embodiment of the invention is formed of a leakage inductor Llk, a magnetizing inductor IM, and a resonance capacitor Cr which are connected in series. Here, the leakage inductor Llk may use leakage inductance of a transformer 30, or may be formed by using an external inductor. The driving voltage VS is input to the resonance network, and a resonance current Icr is controlled according to a switching operation of the high-side switch M1 and the low-side switch M2.

The transformer 30 includes a first wire 31 provided in the primary side of the power supply 1 and a second wire 32 provided in the secondary side of the power supply 1. The magnetizing inductor IM and the leakage inductor Llk respectively indicate a magnetizing inductance component and a leakage inductance component of the transformer 30. A resonance is generated among the magnetizing inductor IM, the leakage inductor Llk, and the resonance capacitor Cr such that the resonance current Icr follows a sine wave.

A capacitor C21, a rectifier circuit 40, and an output capacitor C22 are formed in the secondary side of the power supply 1. The capacitor C21 is connected between the second wire 32 and the rectifier circuit 40, and prevents imbalance of an output current or an output voltage VOUT generated when the switches M1 and M2 in the primary side have different ON duty. However, the capacitor C21 may not be included in the power supply 1.

The rectifier circuit 40 includes four diodes D21 to D24 forming a bridge diode. In FIG. 1, the rectifier circuit 40 is illustrated as a full-wave rectifier circuit, but the rectifier circuit 40 may be realized a half-wave rectifier circuit formed of two or one diode.

The output capacitor C22 is charged by a current that is full-wave rectified by the rectifier circuit 40. The full-wave rectified current charges the capacitor C22 or is supplied to a load.

When the resonance current Icr flows to the direction of “1”, the diode D21 and the diode D23 are conductive, and a current IS in the secondary side flows to the direction of “3”. When the resonance current Icr flows to the direction of “2”, the diode D22 and the diode D24 are conductive, and the current IS of the secondary side flows to the direction of “4”. When the secondary side current IS flows to the direction of 3 and the direction of 4, the capacitor C21 is charged by a current rectified by the rectifier circuit 40 so that the output voltage VOUT is generated.

The power supply 1 includes a sense circuit 20 sensing the resonance current Icr.

The sense circuit 20 generates a first sense voltage VSE to detect a zero voltage switching failure when the resonance current Icr flows to the direction of 1, and generates a second sense voltage VS when the resonance current Icr flows to the direction of 2. The sense circuit 20 according to the exemplary embodiment of the invention uses a capacitive sensing method for sensing the resonance current Icr, and may reduce power consumption that may occur in sensing of the resonance current Icr.

The sense circuit 20 includes a sense capacitor Csense, capacitors C11 and C13, two diodes D11 and D12, and three resistors R11, R12, and R13.

The sense capacitor Csense is connected to the resonance capacitor Cr in parallel. A first end of the sense capacitor Csense is connected to a first end of the resonance capacitor Cr, and a second end of the resonance capacitor Cr is connected to the primary side ground.

A second end of the sense capacitor Csense is connected to a first end of the resistor R11, and a second end of the sense capacitor Csense is connected with a cathode of the diode D11 and an anode of the diode D12. A first end of the resistor R13 and a first end of the capacitor C11 are connected to an anode of the diode D11, and a second end of the resistor R13 and a second end of the capacitor C11 are connected to the primary side ground. A resistor R12 and a capacitor C13 are connected with each other between a cathode of the diode D12 and the primary side ground.

The resonance current Icr flows to the sense capacitor Csense with a predetermined ratio. The predetermined ratio is determined according to a capacitance ratio between the sense capacitor Csense and the resonance capacitor Cr. For example, when the capacitance of the resonance capacitor Cr is 100 times the capacitance of the sense capacitor Csense, 1/101 of the resonance current Icr flows to the sense capacitor Csense and 100/101 of the resonance current Icr flows to the resonance capacitor Cr.

The current flowing to the sense capacitor Csense can be appropriately controlled by controlling the capacitance of the sense capacitor Csense with respect to the capacitance of the resonance capacitor Cr with a predetermined ratio. As the amount of current flowing to the sense capacitor Csense is low, power consumption can be improved, and therefore it is preferred to minimize the capacitance of the sense capacitor Csense within a range for sensing the resonance current Icr.

Further, although a current flowing to the sense capacitor Csense is low, the first sense voltage VSE can be sufficiently amplified by controlling the size of the resistor R12. Then, weakness to noise due to a low level of the first sense voltage VSE can be solved.

The capacitor C13 is connected in parallel with the resistor R12 and filters a noise component of the first sense voltage VSE.

When the resonance current Icr flows to a direction of number 1, the diode D12 is conductive and a current flows to the resistor R12 so that the first sense voltage VSE is generated. The first sense voltage VSE is connected to the switch control circuit 12 through a pin P4.

When the resonance current Icr flows to a direction of number 2, the diode D11 is conductive and thus the current flows to the resistor R13 so that a second sense voltage CS is generated. A part of the resonance current Icr flows from the primary side ground through the resistor R13 and the diode D11. In this case, the capacitor C11 is connected in parallel with the resistor R13 and filters a noise component of the second sense voltage CS. The second sense voltage CS is connected to the switch control circuit 10 through a pin P5. The switch control circuit 10 senses an overcurrent and triggers protection operation using the second sense voltage CS. When the protection operation is triggered, the high-side switch M1 and the low-side switch M2 are turned off and thus the switching operation is not performed.

The reference voltage setting unit 50 sets a zero voltage switching reference voltage VZVS to detect a zero voltage switching failure. For example, the reference voltage setting unit 50 includes a resistor R14 and a capacitor C12 connected in parallel with the resistor R14, and the zero voltage switching reference voltage VZVS according to the resistor R14. The capacitor C12 is a filter capacitor for eliminating a noise component of the voltage switching reference voltage VZVS.

A first end of the resistor R14 is connected to a pin P6 and the zero voltage switching reference voltage VZVS is a voltage of the first end of the resistor R14. The switch control circuit 10 may include a current source supplying a predetermined current to the pin P6. Although the current source is fixed in the switch control circuit 10, the zero voltage switching reference voltage VZVS can be controlled according to a condition that the switch control circuit 10 is applied by controlling the resistor R14.

The switch control circuit 10 controls switching operation of the high-side switch M1 and the low-side switch M2, and detects a zero voltage switching failure by sensing the resonance current Icr at a turn-off time of the high-side switch M1 for each switching cycle. When the zero voltage switching failure is detected, the switch control circuit 10 turns on the high-side switch M1 in the next switching cycle rather than turning on the low-side switch M2 in the switching cycle where the zero voltage switching failure is detected.

The output voltage VOUT fed back to the switch control circuit 10 and the switch control circuit 10 determines a frequency of an oscillator signal OSC that determines a switching frequency based on the output voltage VOUT. For example, when the output voltage VOUT is decreased according to an increase of a load, the switch control circuit 10 can decrease the frequency of the oscillator signal OSC to decrease the switching frequency. On the contrary, when the output voltage VOUT is increased according to the decrease of the load, the switch control circuit 10 can increase the frequency of the oscillator signal OSC to increase the switching frequency.

As the switching frequency is decreased, a switching cycle is longer and the peak of the resonance current Icr is increased so that power transmitted to the secondary side is increased. As the switching frequency is increased, the switching cycle is shorter and the peak of the resonance current Icr is decreased so that power transmitted to the secondary side is reduced.

Further, in the exemplary embodiment of the invention, a zero voltage switching failure is detected by sensing the resonance current Icr at the turn-off time of the high-side switch M1, but the invention is not limited thereto.

For example, when the low-side switch M2 is turned on while the resonance current Icr is a positive current (the polarity of a resonance current flowing to the direction of 1 is positive) and is decreased along the sine wave, the switching operation is occurred at the time that a voltage between the lateral ends of the low-side switch M2 is zero voltage. This is zero voltage switching.

A predetermined dead time exists between the turn-on time of the low-side switch M2 and the turn-off time of the high-side switch M1, but the dead time is very short. Thus, when the resonance current Icr is lower than a predetermined reference current at the turn-off time of the high-side switch M1, the turn-on operation of the low-side switch M2 may not be the zero voltage switching.

In the invention, when the possibility of the zero voltage switching failure is high, the zero voltage switching failure can be prevented by preventing the corresponding switch from being turned on. That is, when the resonance current Icr is lower than the reference current at the turn-off time of the high-side switch M1, the turn-on of the low-side switch M2 is blocked. Thus, when the resonance current Icr is lower than the reference current at the turn-off time of the high-side switch M1, the zero voltage switching is determined to be a failure. The previously-stated zero voltage switching reference voltage VZVS is set to be a voltage corresponding to the reference voltage.

When a connection relationship among the high-side switch M1, the low-side switch M2, and the resonance network of FIG. 1 is deformed so that the resonance current Icr is mostly a positive current during the turn-on period of the low-side switch M2, the zero voltage switching failure can be detected by sensing the resonance current Icr at the turn-off time of the low-side switch M2.

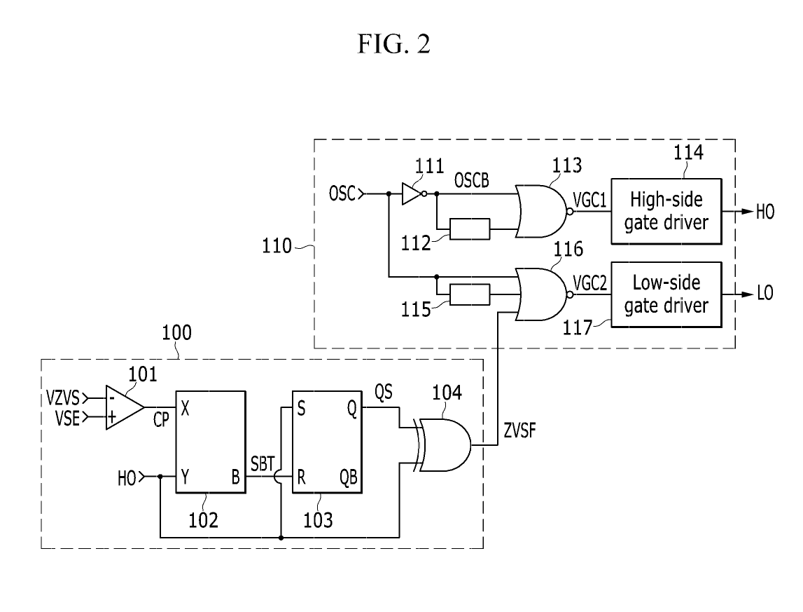

Hereinafter, the switch control circuit 10 according to the exemplary embodiment of the invention will be described with reference to FIG. 2.

FIG. 2 shows the switch circuit control according to the exemplary embodiment of the invention.

As shown in FIG. 2, the switch control circuit 10 includes a zero voltage switching detector 100 and a gate driving circuit 200.

The zero voltage switching detector 100 detects a zero voltage switching failure according to a result of comparison between the first sense voltage VSE and the zero voltage switching reference voltage VZVS at the turn-off time of the high-side switch M1.

The gate driving circuit 200 generates an high gate voltage HO and a low gate voltage LO according to the oscillator signal OSC, and disables the low gate voltage LO of the corresponding switching cycle to which the zero voltage switching failure detection is input from the zero voltage switching detector 100. The disabled low gate voltage LO turns off the low-side switch M2.

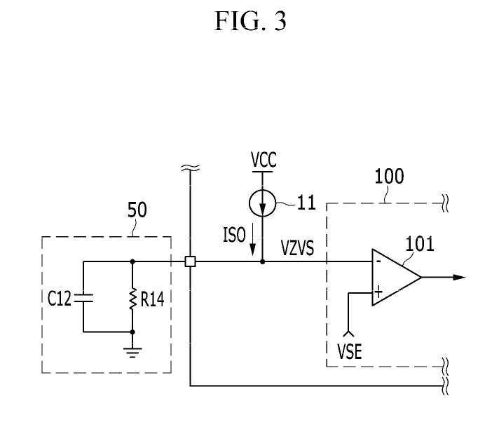

FIG. 3 shows the connection relationship between the switch control circuit and the reference voltage generator according to the exemplary embodiment of the invention.

The switch control circuit 10 includes a current source 11, and the current source 11 is connected with a reference voltage generator 50 through a pin P6. A current ISO of the current source 11 flows to a resistor R14, and the zero voltage switching reference voltage VZVS is supplied to an inverse terminal (−) of a comparator 101 through the pin P6. The current source 11 is connected to the power voltage VCC and biased by the power voltage VCC.

The zero voltage switching detector 100 includes the comparator 101, a half subtractor 102, an SR latch 103, and a logic gate 104.

The comparator 101 compares the first sense voltage VSE and the zero voltage switching reference voltage VZVS and outputs a comparison result. The comparator 101 includes a non-inverse terminal (+) to which the first sense voltage VSE is input and an inverse terminal (−) to which the zero voltage switching reference voltage VZVS is input. The comparator 101 outputs a high-level output when the input of the non-inverse terminal (+) is higher than the input of the inverse terminal (−), and outputs a low-level output in the opposite case.

For example, when the first sense voltage VSE is higher than the zero voltage switching reference voltage VZVS, a comparison signal CP which is the output of the comparator 101 is high level. When the first sense voltage VSE is lower than the zero voltage switching reference voltage VZVS, the comparison signal CP is low level.

The half subtractor 102 receives the high gate voltage HO, and generates a subtraction signal SBT according to a voltage difference between the comparison signal CP and the high gate voltage HO. For example, the half subtractor 102 generates a high-level subtraction signal SBT when a voltage obtained by subtracting the high gate voltage HO from the comparison signal CP is higher than zero voltage, and generates a low-level subtraction signal SBT in the opposite case.

The comparison signal CP is input to the X terminal of the half subtractor 102 and the high gate voltage HO is input to the Y terminal of the half subtractor 102, and the subtraction signal SBT is output through the B terminal of the half subtractor 102.

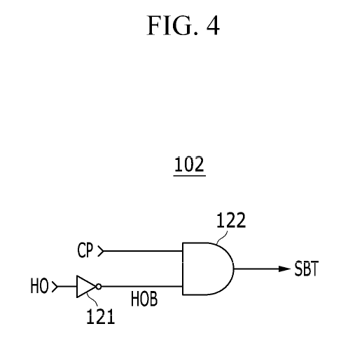

FIG. 4 shows the half subtractor according to the exemplary embodiment of the invention.

As shown in FIG. 4, the half subtractor 102 includes an NOT gate 121 and an AND gate 122. The NOT gate 102 inverts the high gate voltage HO, and the AND gate 122 generates the subtraction signal SBT by performing AND operation on the inversed high gate voltage HOB and the comparison signal CP.

The SR latch 103 generates an output signal QS according to the high gate voltage HO and the subtraction signal SBT, respectively input to a set terminal S and a reset terminal R. The SR latch 103 generates a high-level output signal QS when the input of the set terminal S is high level, and generates a low-level output signal QS when the input of the reset terminal R is high level. That is, the SR latch 103 generates the output signal QS by the high gate voltage HO, which is the input of the set terminal S, and resets the output signal QS according to the subtraction signal SBT.

The logic gate 104 generates a high-level zero voltage switching detection signal VZSF when one of the two inputs is high level, and generates a low-level zero voltage switching detection signal ZVSF when both of the two inputs are high level or low level. When the high-level zero voltage switching detection signal ZVSF indicates a zero voltage switching failure.

The gate driving circuit 110 includes an inverter 111, two dead time units 112 and 115, two NOR gates 113 and 116, an high-side gate driver 114, and a low-side gate driver 117.

The inverter 111 generates an inverse oscillator signal OSCB by inverting the oscillator signal OSC.

The dead time unit 112 delays the inverse oscillator signal OSCB by a dead time DT and then outputs.

The NOR gate 113 generates a high-level gate control signal VGC1 when both of the two inputs are low level, and generates a low-level gate control signal VGC1 when at least one of the two inputs is high level. For example, during a period that both of the inverse oscillator signal OSCB and the inverse oscillator signal OSCB delayed by the dead time are low level, the NOR gate 113 generates the high level gate control signal VGC1.

The high-side gate driver 114 generates the high gate voltage HO according to the gate control signal VGC1. For example, the high-side gate driver 114 generates a high-level high gate voltage HO while the gate control signal VGC1 is high level. The high-side gate driver 114 generates a low-level high gate voltage HO while the gate control signal VGC1 is low level.

The dead time unit 115 delays the oscillator signal OSC by the dead time DT and then outputs.

The NOR gate 116 generates a high-level gate control signal VGC2 when both of the two inputs are low level, and generates a low-level gate control signal VGC2 when at least one of the two inputs is high level. For example, during a period that both of the oscillator signal OSC and the oscillator signal OSC delayed by the dead time are low level, the NOR gate 116 generates a high-level gate control signal VGC2.

The low-side gate driver 117 generates the low gate voltage LO according to the gate control signal VGC2. For example, the low-side gate driver 117 generates a high-level low gate voltage LO while the gate control signal VGC2 is high level. The low-side gate driver 117 generates a low-level low-side gate voltage LO while the gate control signal VGC2 is low level.

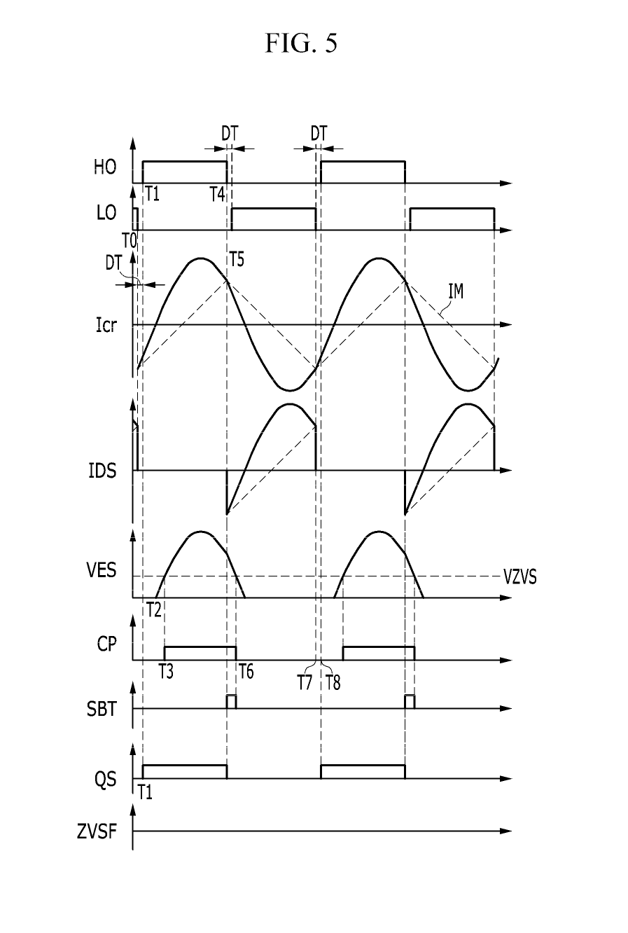

Hereinafter, an operation of the switch control circuit under the zero voltage switching condition according to the exemplary embodiment of the invention will be described with reference to FIG. 5.

FIG. 5 is a waveform diagram of the high gate voltage, the low gate voltage, the resonance current, the drain current, the first sense voltage, the comparison signal, the subtraction signal, the output signal of the SR latch, and the zero voltage switching detection signal according to the exemplary embodiment of the invention.

FIG. 5 is a waveform diagram of a normal state, that is, when the zero voltage switching is normally performed.

As shown in FIG. 5, the low gate voltage LO is decreased to low level and thus the low-side switch M2 is turned off at T0, and the high gate voltage HO is increased to high level at T1 that is delayed by the dead time DT from the time T0. The high-side switch M1 is turned on by the high-level high gate voltage HO.

A magnetized current IM flowing to the magnetizing inductor LM is decreased during the turn-on period of the low-side switch M2, and the magnetized current IM is increased during the turn-on period of the high-side switch M1. The resonance current Icr follows to the sine wave as shown in FIG. 5.

The SR latch 103 generates a high-level output signal QS in synchronization with a rising edge of the high gate voltage HO of the time T1. The increasing resonance current Icr becomes a positive current from a time T2 and thus a diode D12 is conductive, thereby the first sense voltage VSE is generated.

As previously stated, since the current flowing to the sense capacitor Csense has a predetermined ratio to the resonance current Icr, a waveform of the current flowing to the sense capacitor Csense follows the resonance current Icr. Thus, while the diode D12 is conductive, the waveform of the first sense voltage VSE follows the waveform of the resonance current Icr.

At T3, the first sense voltage VSE reaches the zero voltage switching reference voltage VZVS and thus the comparison signal CP is increased to high level. At T4, the high gate voltage HO is decreased to low level and thus the high-side switch M1 is turned off, and the magnetized current IM starts to decrease. At T5 that is delayed by the dead time DT from the time T4, the low gate voltage LO is increased to high level and thus the low-side switch M2 is turned on.

When the high-side switch M1 is turned off at T4, a current starts to flow through a body diode (not shown) of the low-side switch M2. A drain current IDS flowing to the low-side switch M2 flows from a drain to a source, and thus, as shown in FIG. 5, the waveform of the drain current IDS has the opposite polarity to the waveform of the resonance current Icr.

Since the high gate voltage HO is decreased to low level at T4, a high-level subtraction signal SBT is generated according to a result of subtraction (i.e., a positive voltage) of the high gate voltage HO from the comparison signal CP. At T6, the first sense voltage VSE becomes lower than the zero voltage switching reference voltage VZVS so that the comparison signal CP becomes low level. Then, since a different between the high gate voltage HO and the comparison signal CP is zero voltage, the half subtractor 102 generates a low-level subtraction signal SBT.

That is, the subtraction signal SBT has a pulse waveform that is increased to high level at T4 and then decreased to low level at T6. The Since the high-level subtraction signal SBT is supplied to the reset terminal R of the SR latch 103 at T4 (in this case, a low-level high gate voltage HO is input to the set terminal S), the SR latch 103 outputs a low-level output signal QS.

Then, the output signal QS and the high gate voltage HO are both high level or low level, and therefore the zero voltage switching detection signal ZVSF, which is the output of the logic gate 104 is maintained in low level.

The low gate voltage LO is decreased again to low level at T7, and the high gate voltage HO is increased again to high level at T8 that is delayed by the dead time DT from the time T7. An operation after the above-stated operation is the same as the operation performed during a period from T0 to T6, and therefore no further description will be provided.

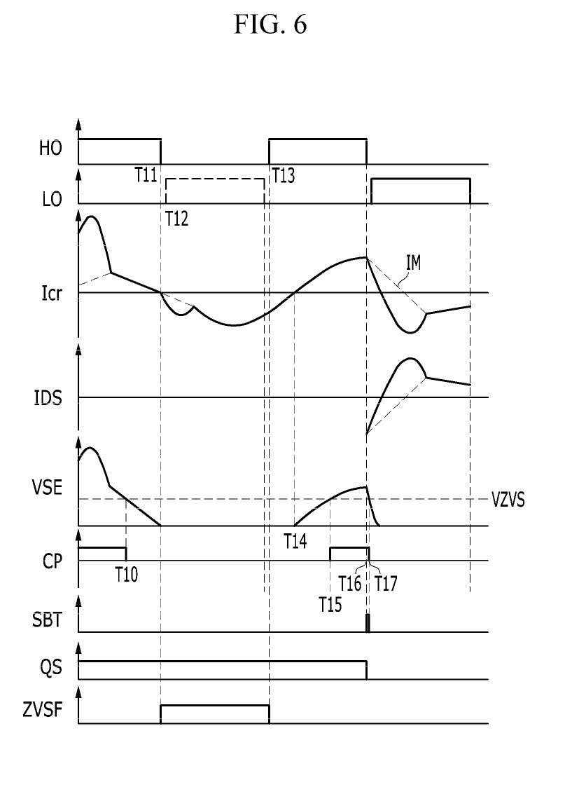

FIG. 6 is a waveform diagram of the high gate voltage, the low gate voltage, the resonance voltage, the drain current, the first sense voltage, the comparison signal, the subtraction signal, the output signal of the SR latch, and the zero voltage switching detection signal according to the exemplary embodiment of the invention.

FIG. 6 shows waveforms illustrating an abnormal state due to a zero voltage switching failure. When the zero voltage switching is failed, for example, the high-side switch M1 and the low-side switch M2 perform switching operation according to the zero current switching, the resonance current Icr may be decreased to zero or a negative current before the high-side switch M1 is turned off.

As shown in FIG. 6, at T10 during the turn-on period of the high-side switch M1, the sense voltage VSE reaches the zero voltage switching reference voltage VZVS. Then, the comparison signal CP is decreased to low level.

Since the high-side gate voltage HO is decreased to low level at T11, a falling edge time of the high-side gate voltage HO is later than a falling edge time of the comparison signal CP. Therefore, the subtraction signal SBT is maintained in low level. The reset terminal R of the SR latch 103 is not supplied with a high level signal, and therefore the SR latch 103 maintains a high-level output signal QS.

Then, the output signal QS among two inputs supplied to the logic gate 104 is high level and the high-side gate voltage HO becomes low level at T11, and therefore the zero voltage switching detection signal ZVSF is increased to high level.

From the time T11, the high-level zero voltage switching detection signal ZVSF is input to the NOR gate 116 of the gate driving circuit 110. In a normal state, the low-side gate voltage LO should be increased to high level at T12 that is delayed by the dead time DT from the time T11. However, since the zero voltage switching detection signal ZVSF is high level, the NOR gate 116 generates a low-level gate control signal VGC2. That is, the low-side gate voltage LO is maintained in low level rather than being increased to high level so that the low-side switch M2 cannot be turned on in the present switching cycle.

Then, as shown in FIG. 6, the waveform of the resonance current Icr is deformed to a gentle curve such that the phase of the resonance current Icr is delayed.

When the high-side gate voltage HO is increased to high level at T13, two inputs of the logic gate 104 become high level so that the zero voltage switching detection signal ZVSF becomes low level. The high-side switch M1 perform zero voltage switching at T13 due to the phase delay of the resonance current Icr.

The first sense voltage VSE is generated at T14, and the first sense voltage VSE reaches the zero voltage switching reference voltage VZVS. Then, the comparison signal CP is increased to high level at T15.

The high-side gate voltage HO is decreased to low level at T16, and the first sense voltage VSE becomes lower than the zero voltage switching reference voltage VZVS at T17 so that the comparison signal CP is decreased to low level.

The half subtractor 102 generates a high-level subtraction signal SBT according to a result of subtraction of the high-side gate voltage HO from the comparison signal CP during a period from the time T16 to the time T17. Since the high-level signal is input to the reset terminal R of the SR latch 103 at T16, the output signal QS is decreased to low level.

As described, when the zero voltage switching is failed and thus the normal state is changed to the abnormal state, the zero voltage switching is recovered by delaying the phase of the resonance current Icr rather than turning on the low-side switch M2.

In FIG. 6, it is illustrated that the zero voltage switching is recovered by sufficiently delaying the resonance current Icr within one switching cycle for description of the exemplary embodiment of the invention, but the invention is not limited thereto.

That is, when the resonance current Icr is not sufficiently delayed, the switching cycle during which the low-side switch M2 is not turned on is repeated, and this is repeated until the resonance current Icr becomes a positive current at the turn-on time of the high-side switch M1 due to the delay of the resonance current Icr.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

power supply 1, high-side switch M1, low-side switch M2
magnetizing inductor IM, leakage inductor Llk, resonance capacitor Cr
transformer 30, first wire 31, second wire 32
capacitor C11, C12, C13, C21, rectifier circuit 40, output capacitor C22
diode D11, D12, D21-D24
sense circuit 20, sense capacitor Csense
resistor R11, R12, R13, R14, reference voltage setting unit 50
switch control circuit 10, current source 11
zero voltage switching detector 100, gate driving circuit 200
comparator 101, half subtractor 102, SR latch 103
logic gate 104, inverter 111
dead time unit 112 and 115, NOR gate 113 and 116
high-side gate driver 114, low-side gate driver 117
NOT gate 121, AND gate 122

What is claimed is:

1. A power supply comprising:
a first switch;
a second switch coupled in series to the first switch;
a transformer coupled to a node where the first switch and the second switch are coupled;
a resonance capacitor coupled between the transformer and a primary side ground and to which a resonance current flows;
a sense circuit configured to generate a first sense voltage that depends on the resonance current when the resonance current is a positive current; and
a switch control circuit configured to detect a zero voltage switching failure by sensing the resonance current using the first sense voltage at a turn-off time of the first switch for every switching cycle of the first and second switches.

2. The power supply of claim 1, wherein the transformer comprises a magnetizing inductor and a leakage inductor coupled in series to the resonance capacitor.

3. The power supply of claim 1, wherein the sense circuit comprises:
a sense capacitor coupled in parallel with the resonance capacitor;
a first diode including an anode coupled to the sense capacitor;
a first resistor coupled between a cathode of the diode and a ground; and
a first capacitor coupled in parallel with the first resistor,
wherein the first sense voltage is a voltage of the first resistor.

4. The power supply of claim 3, wherein the sense circuit further comprises a second resistor coupled between the sense capacitor and the first diode.

5. The power supply of claim 3, wherein
the sense circuit is configured to generate a second sense voltage when the resonance current is a negative current, and the second sense voltage is used in sensing of over-current.

6. The power supply of claim 5, wherein the sense circuit further comprises:
a second diode including a cathode coupled to the sense capacitor through a second resistor;
a third resistor coupled between an anode of the second diode and a ground; and
a second capacitor coupled in parallel with the third resistor, and
wherein the second sense voltage is a voltage of the second resistor.

7. The power supply of claim 1, further comprising a reference voltage setting unit configured to set a zero voltage switching reference voltage for detection of the zero voltage switching failure.

8. The power supply of claim 7, wherein the reference voltage sensing unit comprises:
a third resistor to which a current supplied from the switching control circuit flows and
a third capacitor coupled in parallel with the third resistor.

9. The power supply of claim 1, wherein the switch control circuit is configured to turn on a first high-side switch in the next switching cycle rather than turning on the second switch in a switching cycle in which the zero voltage switching failure is detected.

10. The power supply of claim 9, wherein the switching control circuit comprises a zero voltage switching detector configured to detect whether the zero voltage switching has failed according to a result of comparison between the first sense voltage and a predetermined zero voltage switching reference voltage at a turn-off time of the first switch.

11. The power supply of claim 10, wherein the zero voltage switching detector comprises:
a comparator configured to compare the first sense voltage and the zero voltage switching reference voltage and to output a comparison signal according to a comparison result;
a half subtractor configured to generate a subtraction signal according to a voltage difference between the comparison signal and a first gate voltage supplied to a gate of the first switch;
an SR latch configured to reset an output generated by the first gate voltage according to the subtraction signal; and
a logic gate configured to generate a zero voltage switching detection signal by performing a logic operation on the first gate voltage and an output signal of the SR latch.

12. The power supply of claim 11, wherein the comparator comprises a non-inverse terminal to which the first sense voltage is input and an inverse terminal to which the zero voltage switching reference voltage is input, and the comparator is configured to output a high-level comparison signal when an input of the non-inverse terminal is higher than an input of the inverse terminal and outputs a low-level comparison signal in the opposite case.

13. The power supply of claim 12, wherein the half subtractor is configured to generate a high-level subtraction signal when a voltage obtained by subtracting the first gate voltage from the comparison signal is higher than zero voltage, and to generate a low-level subtraction signal in the opposite case.

14. The power supply of claim 13, wherein the half subtractor comprises:
an NOR gate configured to invert the first gate voltage, and
an AND gate configured to perform an AND operation on the inverted first gate voltage and the comparison signal.

15. The power supply of claim 13, wherein the logic gate is configured to generate a high-level zero voltage switching detection signal when one of the two inputs is high level and to generate a low-level zero voltage switching detection signal when both of the two inputs are high level or low level.

16. The power supply of claim 10, further comprising a gate driving circuit configured to generate a first gate voltage and a second gate voltage according to an oscillator signal that determines switching frequencies of the first and second switches and to disable a second gate voltage of the corresponding switching cycle during which detection of a zero voltage switching failure is input from the zero voltage switching detector.

17. A method for driving a power supply including a first switch, a second switch, and a resonance capacitor coupled between a transformer coupled to a node where the first switch and the second switch are coupled and a primary side ground, the first switch and the second switch being coupled in series, comprising:
generating a first sense voltage that depends on a resonance current when a current flowing to the resonance capacitor is a positive current;
detecting a zero voltage switching failure according to a result of a comparison between the first sense voltage and a predetermined zero voltage switching detection voltage at a turn-off time of the first switch for every switching cycle of the first and second switches; and
maintaining the second switching in a turn-off state during the corresponding switching cycle in which the zero voltage switching failure is detected.

18. The method for driving the power supply of claim 17, wherein the detecting the zero voltage switching failure includes detecting the zero voltage switching to be failed when the first sense voltage is lower than the zero voltage switching detection voltage at a turn-off time of the first switch.

19. A switch control circuit of a power supply including a first switch, a second switch, and a resonance capacitor coupled between a transformer coupled to a node where the first switch and the second switch are coupled and a primary side ground, the first switch and the second switch being coupled in series, comprising:
a comparator configured to compare a first sense voltage generated when a resonance current flowing to the resonance capacitor with a predetermined zero voltage switching reference voltage and to output a comparison signal according to a result of the comparison;
a half subtractor configured to generate a subtraction signal according to a voltage difference between the comparison signal and a first gate voltage supplied to a gate of the first switch;
an SR latch configured to reset an output generated by the first gate voltage according to the subtraction signal; and
a logic gate configured to generate a zero voltage switching detection signal by performing a logic operation on the first gate voltage and an output signal of the SR latch.

20. The switch control circuit of claim 19, wherein when the zero voltage switching detection signal indicates a failure of zero voltage switching, the switch control circuit is configured to turn on a first high-side switch in the next switching cycle rather than turning on the second switch in the corresponding switching cycle.

21. The switch control circuit of claim 19, wherein the switch control circuit is configured to generate a gate voltage of the second switch using an oscillator signal that determines switching frequencies of the first and second switches, a signal generated by being delayed by a predetermined dead time from the oscillator, and a gate voltage of the second switch using an output of the logic gate.

22. The switch control circuit of claim 19, wherein the half subtractor includes an NOR gate configured to invert the first gate voltage and an AND gate configured to perform an AND operation on the inverted first gate voltage and the comparison signal.
